(19) United States
(12) Patent Application Publication
(10) Pub. No.: US 2024/0082806 A1
(43) Pub. Date: Mar. 14, 2024

(54) NANOSCALE MATERIALS SYNTHESIS MACHINE

(71) Applicants: ISHU SINGHAL, Shahdara, Delhi (IN); INDER KUMAR GUPTA, Shahdara, Delhi (IN); KANIKA GUPTA, Shahdara, Delhi (IN)

(72) Inventors: ISHU SINGHAL, Shahdara, Delhi (IN); INDER KUMAR GUPTA, Shahdara, Delhi (IN); KANIKA GUPTA, Shahdara, Delhi (IN); RAVI SINGHAL, Shahdara, Delhi (IN)

(21) Appl. No.: 18/261,669

(22) PCT Filed: Mar. 1, 2022
(86) PCT No.: PCT/IN2022/050175

§ 371 Date: Jul. 18, 2023

(30) Foreign Application Priority Data
Mar. 3, 2021 (IN) 202111004717
Mar. 1, 2022 (WO) PCT/IN2022/050175

(51) Int. Cl. B01J 19/00; C01B 32/168

(52) U.S. Cl. CPC B01J 19/0053; B01J 19/0006; C01B 32/168; B82Y 40/00; C01B 2202/06; C01P 2002/01; C01P 2002/72; C01P 2002/82; C01P 2002/85; C01P 2004/03

(57) ABSTRACT

An automated nanomaterials synthesis machine system along with its accompanying graphical user interface (GUI) and variable power supply is disclosed and described. The nanoscale material synthesis system allows the users, the combination and permutation of precursors and of measurable, controllable, recordable parameters of environment and creates facilities for almost infinite possibilities of creativity, observation, study, manipulation of nanoscale, microscale or bigger materials.

### TECHNICAL FIELD OF THE INVENTION

Embodiments of the present invention relates to the field of nanotechnology and a system i.e., nanoscale materials synthesis machine comprising a graphical user interface software application that can synthesize or manipulate varied types of nanoscale materials with their different desired properties and quantities.

### BACKGROUND OF THE INVENTION

The properties of materials change drastically at nanoscale, which are being exploited to achieve varied desired applications.

Nanotechnology and nanoscale materials are the need and pillar of fourth industrial revolution, applicable to almost all fields of industries and life such as material industry, rubber, metal industries, plastic, automobile, defense, space, medicine, drug development and delivery, nanofluids, nanostructures based diagnostic techniques, nano virology, nano biotechnology, and many more.

The study, experiment, interference, alteration, modification, synthesis and procurement of nanoscale materials is the first step to facilitate their real time application, research, development, large scale Incorporation, and many more in any field.

Currently, to synthesize or manipulate, manufacture variety of nanoscale materials, a single unified platform, standardized protocol, real time monitoring of different nanoscale events is highly deficient and need of the hour.

So, there is a strong need of a unified, cost effective, user friendly, automated, active system interface to achieve above said demands with different desired properties in different quality and quantity.

### SUMMARY OF THE INVENTION

Realizing the need of a unified, cost effective, end user friendly, automated, active machine/system interface in the field of nanotechnology for the fast progressing fourth industrial revolution, we have invented, developed a machine comprising a graphical user interface (GUI) software to solve the problems of prior art and to fulfill the demand of including but not limited to academic institutions, research laboratories, industries, students, academicians, researchers.

In an embodiment an automated system/machine comprising a graphical user interface (GUI) and firmware, is invented and developed to perform varying events such as manipulation, synthesis manufacture, experiment, reaction, study, alteration, modification, research, and or development of a wide range of nanoscale materials, including but not limited to metal, metal oxide, metal hydroxides, metal carbonates, thin films, nano rods, multi metal oxide nanomaterials, nanoscale material's dispersions, nanoconjugates, nanocomposites, nano coatings, nanoscale materials with different size, morphology, concentration, surface modifications, functionalization, conjugations, biocompatible nanomaterials with polymeric coating and many more in different mediums in different quantity.

In an embodiment, the system/machine works by applying different parameters including but not limited to different measurable, controllable, recordable variables of main heater temperature, heat, air temperature, humidity, present gas types and values, electromagnetic waves within and beyond range of wavelength of ultra violet, infra-red, visible, microwave, microwave power, electric field output/input voltage/current waveforms, electric field frequency, sonication, sonication power, stirring, stirring/agitation rate, sonicator, water bath temperature, potentiostat/galvanostat methods, pH, pressure, and many more with respect to time on different medium such as solid, liquid, gas media, solvents, solutes and different precursors.

### BRIEF DESCRIPTION OF THE DRAWINGS

FIG. 1 illustrates functional component of the nanoscale material synthesis machine system 100 in accordance with an embodiment of the present disclosure.

FIG. 2 illustrates functional component of computing system 200 of graphical user interface (GUI) interfaced with hardware of nanoscale material synthesis system 100 in accordance with an embodiment of the present disclosure.

FIG. 3 is the drawing (110) of the desktop installable graphical user interface software (GUI) application to operate, control and monitor the nanoscale material synthesis machine system in accordance with an embodiment of the present disclosure.

FIG. 4 is the screenshot (111) of the mobile installable graphical user interface (GUI) to operate, control and monitor the system 100 in accordance with an embodiment of the present disclosure.

FIG. 5 is the screenshot (112) of the touch-display graphical user interface (GUI) to operate, control and monitor the system 100 in accordance with an embodiment of the present disclosure.

FIG. 6 illustrates the process of operation/methodology of nanoscale material synthesis machine system 100 in accordance with an embodiment of the present disclosure.

FIG. 7 illustrates a process of synthesis zinc oxide (ZnO)/MWCNT nanoconjugate (EXAMPLE 1) synthesized in system 100 in accordance with an embodiment of the present disclosure.

FIG. 8 illustrates transmission electron micrograph (TEM) of zinc oxide (ZnO)/MWCNT nanoconjugate (EXAMPLE 1) synthesized in system 100 in accordance with an embodiment of the present disclosure.

FIG. 9 illustrates high-resolution transmission electron micrographs (HRTEM) of zinc oxide (ZnO)/MWCNT nanoconjugate (EXAMPLE 1) synthesized in system 100 in accordance with an embodiment of the present disclosure.

FIG. 10 illustrates Raman spectrogram of zinc oxide (ZnO)/MWCNT nanoconjugate (EXAMPLE 1) synthesized in system 100 in accordance with an embodiment of the present disclosure.

FIG. 11 illustrates transmission electron micrograph (TEM) of copper oxide (CuO) nanostructures (EXAMPLE 2) synthesized in system 100 in accordance with an embodiment of the present disclosure.

FIG. 12 illustrates scanning electron micrograph (SEM) of copper oxide (CuO) nanostructures (EXAMPLE 2) synthesized in system 100 in accordance with an embodiment of the present disclosure.

FIG. 13 illustrates X-ray diffractogram (XRD) of copper oxide (CuO) nanostructures (EXAMPLE 2) synthesized in system 100 in accordance with an embodiment of the present disclosure.

FIG. 14 illustrates energy dispersive X-ray (EDX) analysis of copper oxide (CuO) nanostructures (EXAMPLE 2) synthesized in system 100 in accordance with an embodiment of the present disclosure.

FIG. 15 illustrates transmission electron micrograph (TEM) of ZnMn₂O₄ nanostructures (EXAMPLE 3) synthesized in system 100 in accordance with an embodiment of the present disclosure.

FIG. 16 illustrates X-ray diffractogram (XRD) of ZnMn₂O₄ nanostructures (EXAMPLE 3) synthesized in system 100 in accordance with an embodiment of the present disclosure.

FIG. 17 illustrates transmission electron micrograph (TEM) iron oxide (Fe₃O₄) nanoparticles (EXAMPLE 4) synthesized in system 100 in accordance with an embodiment of the present disclosure.

FIG. 18 illustrates transmission electron micrograph (TEM) iron oxide (Fe₃O₄)/MWCNT nanoconjugate (EXAMPLE 5) synthesized in system 100 in accordance with an embodiment of the present disclosure.

FIG. 19 illustrates Raman spectrogram of iron oxide (Fe₃O₄)/MWCNT nanoconjugate (EXAMPLE 5) synthesized in system 100 in accordance with an embodiment of the present disclosure.

FIG. 20 illustrates X-ray diffractogram (XRD) of zinc oxide (ZnO) nanostructures (EXAMPLE 6) synthesized in system 100 in accordance with an embodiment of the present disclosure.

FIG. 21 illustrates Raman spectrogram of zinc oxide (ZnO) nanostructures (EXAMPLE 6) synthesized in system 100 in accordance with an embodiment of the present disclosure.

### DETAILED DESCRIPTION OF THE INVENTION

The detailed description of various exemplary embodiments of the disclosure is described herein with reference to the accompanying drawings. It should be noted that the embodiments are described herein in such details as to clearly communicate the disclosure. However, the amount of details provided herein is not intended to limit the anticipated variations of embodiments; on the contrary, the intention is to cover including but not limited to all modifications, equivalents, and alternatives falling within the scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

It should also be noted that in some alternative implementations, the functions/acts noted may occur out of the order noted in the figures. For example, two figures shown in succession may, in fact, be executed concurrently or may sometimes be executed in the reverse order, depending upon the functionality/acts involved.

An automated nanomaterials synthesis machine system 100 along with its accompanying graphical user interface (GUI) 110, 111, 112 and variable power supply 106 is disclosed and described herein along with accompanying figures.

In an embodiment, the nanoscale material synthesis system 100 allows the users, the combination and permutation of precursors and of measurable, controllable, recordable parameters of environment and creates facilities for almost infinite possibilities of creativity, observation, study, manipulation of nanoscale, microscale or bigger materials.

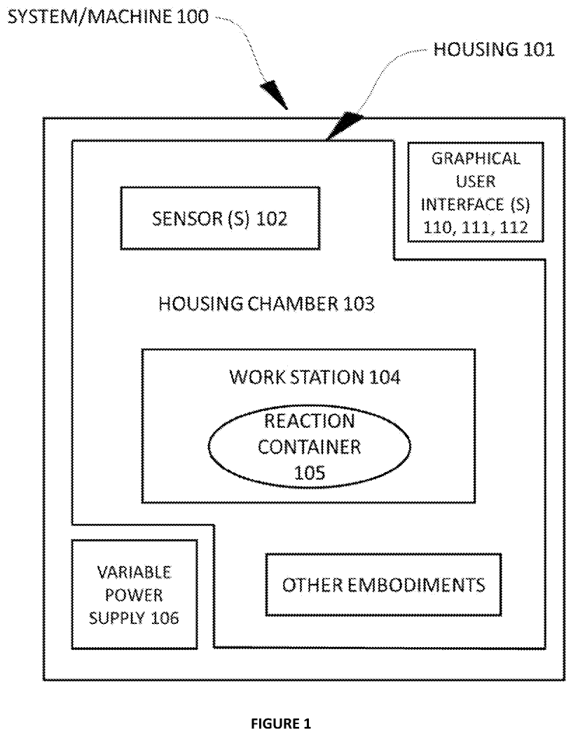

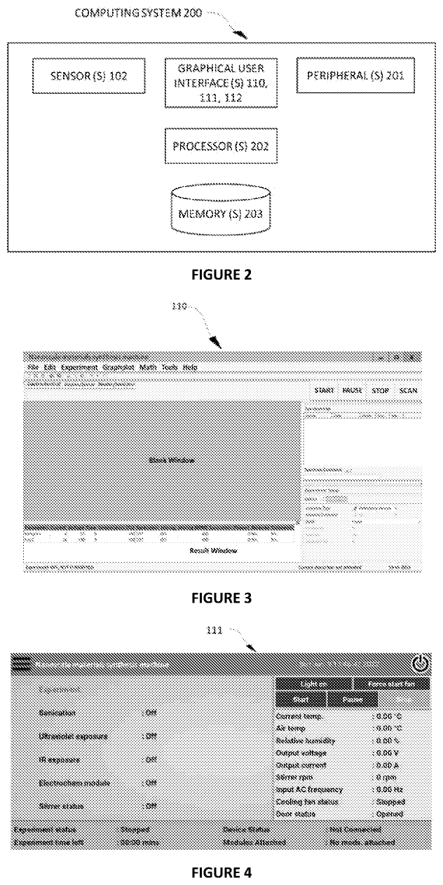

In an embodiment, referring to FIG. 1 that illustrates the functional components of the nanoscale material synthesis machine system 100.

In an embodiment, system/machine 100 FIG. 1 comprises of a housing 101 along with its embodiments, graphical user interface 110, 111, 112, variable power supply 106.

In an embodiment, operating conditions of the system 100 are highly customizable in terms of parameters and or modules, other embodiments that can be applied to varying events.

In an embodiment, system 100 may work manually, semi-automatically, or automatically or in combination, by applying different parameters with any one or in combination of precursors of liquid, gas, solid, plasma medium, solvents, solutes, and different variety of nanoscale, microscale materials with different properties, characteristics for manipulating micro, nanomaterial's properties including but not limited to size, morphology, concentration, surface modifications, functionalization, conjugations, biocompatible nanomaterials with polymeric coating, through varying methods of such as experiments, reaction, study, alteration, modifications, research, development by controlling different operable parameters inputted through the GUI 110, 111, 112 provided with the system 100.

In an embodiment housing 101 comprises of but not limited to a plurality of linear actuators, reaction indicator lights, machine doors opening/closing switches, adjustable castor wheels, connector panels, emergency switches, magnetron, controllers, printed circuit boards, fuses, fuse box, processor(s) 202, memory storage units 203, multiple power supply(s), cooling systems, exhaust systems, power distribution system, cables, interfaces, circuit breakers, Bluetooth modules, Wi-Fi modules and many more.

In an embodiment, the housing 101 comprises of a plurality of touch-display panel of the GUI 112 is mounted on the housing 101 for the user to access the computing system 200.

In an embodiment, the housing 101 comprises of a plurality of adjustable castor wheels comprising but not limited to wheel system, pad system, roller system, and many more.

In an embodiment, the housing 101 comprises of cooling system(s) that acts and functions to provide cooling during the reaction events as per the user requirements.

In an embodiment, the housing 101 comprises of a plurality of actuators to actuate the opening/closing of door of the machine system 100. The actuators may be automated or manually operated. Gas struts or any other type of motion systems may be used for opening/closing of door of the machine 100.

In an embodiment, the housing 101 comprises of a plurality of indicator lights is provided which indicating the different events occurring in the housing 101.

In an embodiment, a plurality of opening/closing switches for housing chamber 103 door is provided on the housing 101. Transparent door may be made up of material or covered with a sheet to block hazardous stray rays as per requirement of the situation to protect the user.

In an embodiment, a plurality of connector panels is mounted on the housing 101 and are provided for connecting main power supply, variable power supply 106, data exchange, interfaces.

In another embodiment the housing chamber 103 may include but not limited to a plurality of sensor(s) 102; that may include but not limited for the temperature, air temperature, humidity, gas, proximity and many more, ultra-violet lights, infra-red lights, visible lights, exhaust system, automated vertical and horizontal motion system, robotic arms, cameras, scale bar, electrode holders, electrodes, heaters, heating plates, bath ultrasonicator, probe ultrasonicator, a stirrer, automatic tool changer, automatic dispenser, liquid handler, and many more.

In an embodiment, housing chamber 103 can be observed, monitored and controlled with respect to time for values of the main heater temperature, air temperature, humidity, gas type, motion system, container positions and many more parameters during the events.

In an embodiment, a plurality of cameras is provided to record, monitor, observe the events in the housing chamber 103. The recorded events can be stored in an inbuilt/internal storage 203 and or to a cloud system through inbuilt Wi-Fi connectivity and or to any external storage system 203. The recorded events can be live streamed to the touch-display affixed on the machine 100, and or any external mobile, desktop, laptop with the help of Bluetooth, Wi-Fi, USB connectivity or any other data transmission system.

In an embodiment the housing chamber 103 comprises of a plurality of workstation 104; for all the events related to manipulation, manufacture, reaction, study, alteration, modifications, research, development of varied types of any desired, required micro, nanoscale and or bigger materials. The workstation 104 platform can be used with closed- or open-door mode.

In an embodiment the housing chamber 103 comprises of a plurality of reaction container(s) 105. The different reaction container(s) 105 can be selected and installed as per requirement and desire of user for the reaction's activities and events. The appropriate reaction container may be loaded or filled with different solvents, and or precursors, electrodes, capping agents, surfactants, reactants, catalysts, surface modifiers, metal salts, polymers, biocompatible ligands, carbon-based nanomaterials/materials and many more.

In an embodiment a plurality of electromagnetic wave sources within and beyond the wavelengths of such as ultra-violet, infra-red, microwave, visible are disposed inside the housing chamber 103. The plurality of electromagnetic wave sources may be used with any one of or in combination during the desired or required events. The housing chamber 103 may be illuminated with microwaves during the experiment and or synthesis event, with the help of a magnetron present in the housing 101.

In an embodiment, an automated vertical motion system, an automated horizontal motion system and or robotic arms are provided inside the housing chamber 103 for handling and manipulation of a plurality of probes such as sensing probe(s), electrode(s), pH probe(s), sonicator probe(s), stirrer probe(s), liquid handler probe(s) during the reaction events. The housing chamber 103 may further include automated vertical and horizontal motion system which may be operated, controlled, and monitored using guide rails system, belt system or screw/rod mechanism and or any other linear motion system mechanism. The multiple electrode holders are provided to hold the electrode(s). The electrode(s) provide variable electric field waveform(s) during the experiment and or synthesis event.

In an embodiment, the housing chamber 103 includes and supports the removable and or replaceable internal linings of the walls of the housing chamber 103. The housing chamber wall linings can be removed in case to clean and or replaced to increase the efficiency and keep the chamber clean.

In an embodiment the computing system 200 with or without the capability of machine learning (ML), artificial intelligence (AI), deep learning and IOT comprises of but not limited to a plurality of peripheral(s) 201, processor(s) 202 that may be implemented as one or more microprocessors, microcomputers, microcontrollers, digital signal processors, central processing units, logic circuitries, and or any devices that manipulate data based on operational instructions. Among other capabilities, the one or more processor(s) 202 are configured to fetch and execute computer-readable instructions stored in a memory(s) 203 of the housing 101.

In an embodiment the processor(s) 202 may be implemented as a combination of hardware and programming (for example, programmable instructions i.e., firmware) to implement one or more functionalities as instructed by the user. In examples described herein, such combinations of hardware and programming may be implemented in several different ways.

In an alternative embodiment, the programming for the processor(s) 202 may be processor executable instructions stored on a non-transitory machine-readable storage medium and the hardware for the processor(s) 202 may comprise a processing resource (for example, one or more processors), to execute such instructions. In such alternative embodiments, the system 100 may comprise the machine-readable storage medium storing the instructions and the processing resource to execute the instructions, or the machine-readable storage medium may be separate but accessible to system 100 and the processing resource. In other examples, the processor(s) 202 may be implemented by electronic circuitry.

In an embodiment the computing system 200 comprises of a plurality of memory(s) 203 that may comprise data that is either stored or generated as a result of functionalities, events of any of the components of the system 100 and or processor(s) 202. The memory(s) 203 may store one or more computer-readable instructions or routines, which may be fetched and executed to create or share the data units over a network service. The memory(s) 203 may comprise any storage device including, for example, volatile memory such as RAM, or non-volatile memory such as EPROM, flash memory, and the like.

In an embodiment the computing system 200 comprises of plurality of interface(s) for data input and output devices, referred to as I/O devices, and other additional embodiments.

In an embodiment the graphical user interface (GUI) comprises of but not limited to a dedicated desktop software application 110 or mobile application 111 or touch-display panel application 112.

In an embodiment the above said parameters, components, parts, reaction events, environment can be observed, operated, monitored, recorded, analyzed and controlled with respect to time using/from any one of the nanoscale materials synthesis machines accompanying graphical user interface (GUI).

In an embodiment the graphical user interface (GUI) 110, 111, 112 is compatible with multiple operating systems like Windows, MacOS, Linux, Android, and many more.

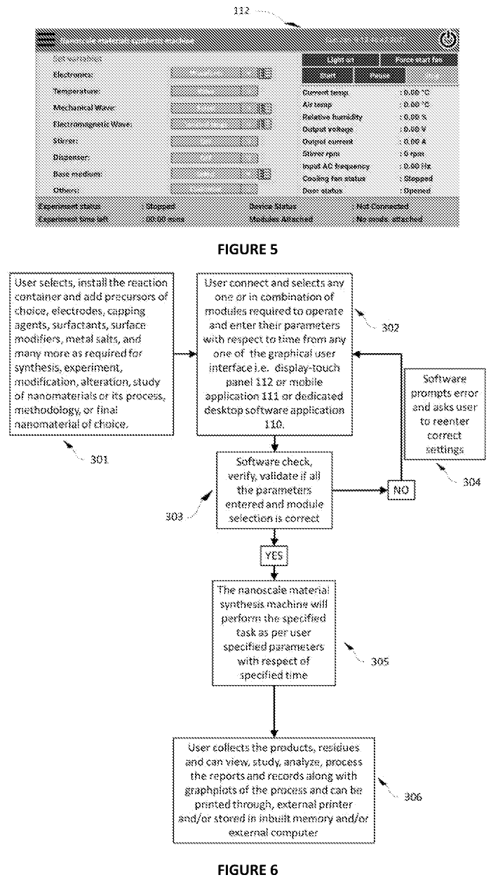

In an embodiment the GUI comprises of, equipped of Tools, Help, View Bar, Measure Bar, Standard Toolbar, Trace Bar, Module Bar, Status Bar, Lamp Bar, and many more, opens up multiple main windows and sub windows such as Graph window, Spectrum window, Results window, Experiment window, Math window, and many more than shown in FIG. 3, FIG. 4 and FIG. 5.

In an embodiment the main menu option File supports multiple commands such as New, Open, Close, Close All, Save, Save As, Open Method, Save Method, Export, Print, Exit, and many more. The main menu option Edit supports subcommands such as Cut, Copy, Paste, Undo, Redo, Delete, delete all, Select, Select all and many more. The main menu option Experiment supports subcommands such as Select module (pops up a new window. It includes the options to select modules, their parameters and other settings required to run experiment), Modules current status, Path, Options, Scan rate, Modes, Select parameters, and many more.

In an embodiment the main menu option Graphplot supports subcommands such as Resulting graphs that can be monitored, accessed, altered, and viewed through this menu. Graph function facilitates a different window popup. It displays including but not limited to the result values of Result window, comment option, data cut/copy/paste options, options to load and view multiple graphplots data files. Trace bar displays X-axis and Y-axis values of the mouse pointer on the spectrum/data of graphplot window.

In an embodiment the main menu option Math includes options including but not limited to commands to analyze the collected or resultant data/spectrum such as Smoothing, Derivative, Scalar Add, Scalar Multiply, Scalar Divide, Log, Add, Subtract, Average, and many more.

In an embodiment the main menu option Tools provides commands such as including but not limited to Windows arrangement options (Tile Horizontally, Tile Vertically, Cascade, etc.), Spectrum List, Spectrum Information, Select/view different toolbars (View Bar, Measure Bar, Standard Toolbar, Trace Bar, Module Bar, Status Bar, Lamp Bar), User Information, Customize, Reset Tool Bar and many more.

In an embodiment the main menu option Help provides details about the current software version, software guide link and its .PDF file format, help guides, link to websites, driver updates, software updates, online support options, and many more.

In an embodiment the machine's accompanying software application provides functionalities to Start, Stop or Pause, Scan, Resume a reaction event. It also has an inbuilt automatic error detection feature in case of any system 100 component's malfunctioning and or incorrect experiment setting entered by the user. The GUI shows the real time connectivity status of the different module's attachment.

In an embodiment, a variable power supply 106 is provided that can be used as an attachment to the housing 101 to provide desired variable electric field, output/input voltage and current, variable waveform of current, voltage frequency output through any one or in combination of each component or separately as desired or required during the experiment and or synthesis event. The variable electronics power supply 106 can be used independently for other purposes or other machines.

In an embodiment, the variable electronics power supply 106 comprises of but not limited to a plurality of switches to control power, voltage, current, indicators, cooling system, exhaust system, touch-display, processors, memory, controllers, circuit boards, motors, gears, limit switches, adjustable castor wheel and or padding and many more.

In an embodiment, the variable power supply 106 electric field's waveforms type can be observed, monitored, changed and selected such as including but not limited to sine wave, square wave, sawtooth, pulsating, triangle, sinusoidal, and many more. The power supply values of voltage and current can be observed, monitored, changed and selected including but not limited to the variable Alternating current (AC)/Direct current (DC) component, filtered, full wave or half wave or variably rectified waveforms. The values can be selected and changed appropriately such as average, root mean square (RMS), peak (PK), peak to peak (PK to PK), and many more.

In an embodiment, the variable power supply 106 frequency values can be observed, monitored, changed and controlled. Multiple desired output waveforms can be selected with respect to time, by selecting and controlling the types of waveforms with their appropriate magnitude/values for a specified time. The multiple output waveforms can be selected parallel or serially, with the help of multiple electrodes that can be fixed with electrode holders.

In an embodiment, the variable power supply 106 is accompanied with a dedicated graphical user interface (GUI) is operable on multiple devices including but not limited to touch-display panel, desktop, mobile phone, tablets.

In an embodiment, the variable power supply 106 accompanying GUI is compatible with multiple operating systems like Windows, MacOS, Linux, Android, and many more for observation, control, operation, management, recording, analysis, during the experiment and or synthesis events in conjunction with the housing 101 or for other purposes and or other machine.

In an embodiment, the variable power supply 106 comprises one or more processors that can be implemented as one or more microprocessors, microcomputers, microcontrollers, digital signal processors, central processing units, logic circuitries, and or any devices that manipulate data based on operational instructions. Among other capabilities, the processor is configured to fetch and execute computer-readable instructions stored in a memory(s) of the variable power supply 106. The processors and or controllers implement as a combination of hardware and programming (for example, programmable instructions i.e., firmware) to implement one or more functionalities as instructed by the user. The storage may comprise data that is either stored or generated as a result of functionalities implemented by any of the components of the variable power supply 106 and or processor.

In an embodiment the system 100 comprises of a plurality of safety features that include but not limited to a plurality of environment monitoring sensor(s) that are present in the housing 101 and housing chamber 103. The environment sensor(s) may be humidity sensor(s), temperature sensor(s), electromagnetic spectrum sensor(s) to monitor malfunctioning of the system or working during the experiment and or synthesis event beyond workable ranges. A cooling system to regulate adverse temperature ranges is present in the housing 101. The housing 101 comprises of including but not limited to a plurality of thermal and electrical insulation system, fuses, voltage stabilizers, circuit breaker(s), earthing system. The housing chamber 103 includes a fire extinguishing system for unwanted fire and prevention. The fire extinguishing system works automatically with the feedback from a plurality of thermal environmental monitoring sensor(s) or can be monitored, controlled, manually. An emergency switch is provided to stop/pause to handle any event in case of emergencies.

In an embodiment, the housing chamber 103 is provided with an exhaust system attached with the housing 101 that acts and functions to reduce the fumes or gases generated during the experiment and or synthesis event. The housing chamber 103 exhaust system comprises of a plurality of including but not limited to filters, scrubbers, membranes and or water/air regulation system as per the user requirement.

The operating conditions of the system 100 are customizable in terms of different parameters that can be applied to varying methods of events including but not limited to such as manipulation, manufacture, reaction, study, alteration, modifications, research, development of varied types of nanoscale, microscale or bigger materials as desired and required by the user.

Different Parameters of the machine system 100 including but not limited to such as related to main heater temperature, air temperature, humidity, present gas types and values, electromagnetic waves within and beyond range of wavelength of ultra violet, infra-red, visible, microwave, microwave power, electric field output/input voltage/current waveforms, electric field frequency, sonication, sonication power, stirring, stirring/agitation rate, sonicator water bath temperature, potentiostat/galvanostat methods, pH, pressure, and many more with respect to time can be set, controlled, observed, monitored.

In an embodiment, the general method of operation FIG. 6 is disclosed and described of nanoscale material synthesis machine system 100. The user has freedom and choice to follow innovative, improvised other ways as per requirement or desire but within the threshold limits and safety requirements of the machine 100;

At, block 301, the appropriate reaction container 105 is selected, installed and prepared by adding medium such as liquid, gas, solid, appropriate precursors, electrodes, capping agents, surfactants, reactants, catalysts, surface modifiers, metal salts, polymers, biocompatible ligands, carbon-based nanomaterials/materials, and many more as per requirement. Where in, the user can mount/fix/attach any type of desired or required one or more electrodes to the electrode holder manually and or automatically.

At block 302, any one or in combination of desired separate modules such as variable power supply 106 is connected to the machine 100. The machine 100 is powered up.

At block 302, using the GUI 110, 111, 112, the user enters and set the parameters for such as sonication, electromagnetic lights illumination, temperature, types of electrodes, number of electrodes, pH scan rates, and control, dispensing of any precursor in, before and or during the reaction event, or any other combination as required. User set the desired reaction time and or cycles of reaction events. Where in, the user enters instructions using GUI 110, 111, 112 for the electrodes, sensing probes, dispensing probes, and other kinds of probes to work automatically with the help of robotic arms, linear axis movement systems, and or automatic tool changers and or manual mode as per the requirements or desire.

At block 303 the computing system, may check if the inputted parameters and selected module fulfills the conditions and validate as per predefined limitation data related to parameters, procedures and modules for each process. In case 304, the parameters entered and modules selected are analyzed to be incorrect based on pre-defined data then an error notification is displayed on the GUI 110, 111, 112 and the user is prompted to re-enter correct setting inputs.

At block 305, once the parameters entered and modules selected are verified to be correct, the process progress to close the housing 101 door, and starts the event based on the inputted parameters and specified time.

Where in, the emergency switch may be activated to pause or abort the reaction being performed in the machine 100 in case of any aberrant situation detected based on sensor(s), based on pre-defined thresholds related to operational parameters.

Where in, in case of any unwanted temperature surges, or malfunction of any system 100 components, or fire, or safety breach, or readings of environment monitoring sensor(s) above or below the tolerance limits defined, or any fault in the power distribution system. the system 100 may start on its own defined safety actions/procedures such as pausing, stopping of the running event, trigger on the automatic fire extinguisher, alarm, disconnection of power supply and distribution, sealing of doors and or other safety measure. The error may be displayed on the display screen.

At block 306, after completion of the reaction, the product i.e., X nanostructures, micro or bigger materials can be collected as prepared or can be further processed by further manipulation, synthesis and or experiment events. The reports and records related to the events and reaction may be viewed by the user over the GUI 110, 111, 112. The reports may be in form of Graphplots, records reaction, video recording of process events with respect of duration of time, date and time, sensor(s) values, feedback, values of parameters used and many more can be printed through printer, replayed as video and or stored in inbuilt memory(s) 203 and or external memory.

### EXAMPLES

The nanoscale material synthesis system 100 allows the users, the combination and permutation of precursors and of controllable parameters of environment and creates facilities for almost infinite possibilities of creativity, observation, study of nanoscale materials and some out of these conventional and non-conventional nanoscale products examples are herewith given to support claims for novelty, non-obviousness of machine, methods, process and for its academic and commercial, utility.

Following examples out of many more are herein described and illustrated; They should not be construed to limit the scope of the invention.

### Example 1

### Synthesis Process 400 of Zinc Oxide (ZnO)/MWCNT Nanoconjugate:

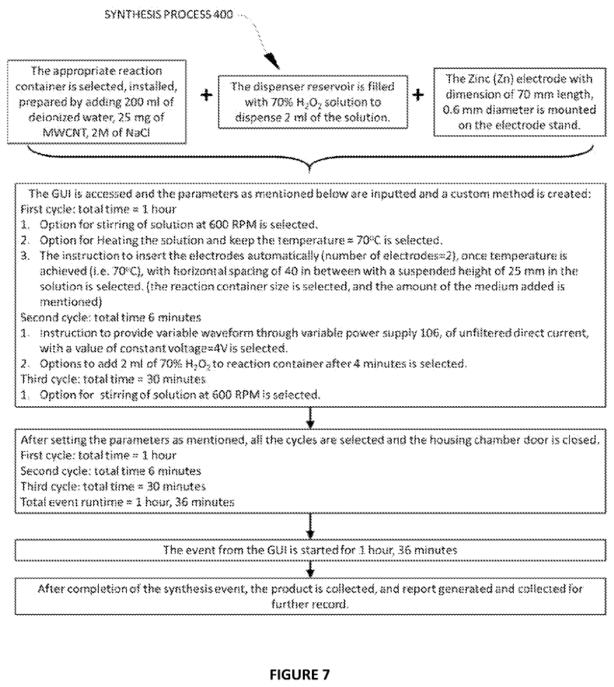

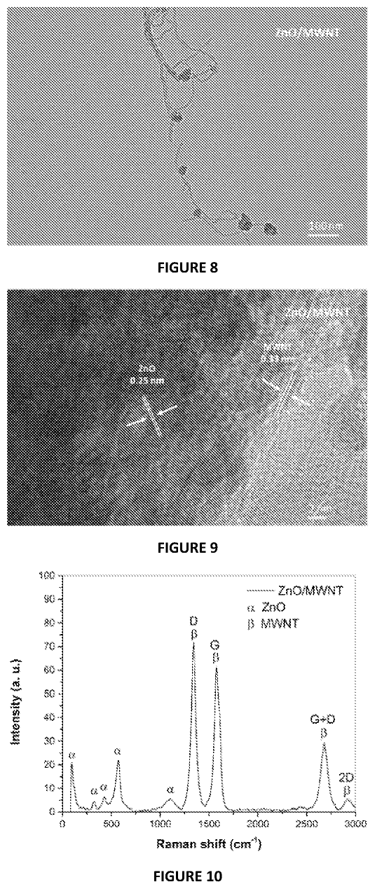

The detailed process of synthesis of zinc oxide (ZnO)/MWCNT nanoconjugate that may have various application in the field of biotechnology, industries such as paint, coatings, automobile, and many more, is disclosed and described herein along with figures, i.e., FIG. 7, FIG. 8, FIG. 9, FIG. 10.

At First, the reaction container 105 is filled with 200 ml of deionized water, 25 mg of MWCNT, and 2 M of NaCl are added. Then the reaction container 105 on the workstation 104 is placed/mounted/attached.

The dispensing reservoir in the housing chamber 103, is filled to dispense 2 ml of 70% H₂O₂.

The Zinc (Zn) electrode with dimension 70 mm length, 0.6 mm diameter is mounted on electrode stand.

A fully customized three event cycle with different parameters and timeline is created for synthesis of zinc oxide (ZnO)/MWCNT nanoconjugate. The instructions are entered through GUI.

The first cycle of one hour is created, with continuous stirring of the solution at 600 RMP, and heating of up to 70° C. The instruction on achieving a temperature of 70° C. in reaction container 105. to insert the electrodes with horizontal spacing of 40 mm in between, a suspended height of 25 mm in the solution automatically (number of electrodes=2) is entered.

Now the second cycle is created with continuous stirring of the solution at 600 RMP, continuous heating of solution to maintain a temperature of 70° C., and variable waveform through variable power supply 106, of unfiltered direct current, with a value of constant voltage=4V. The instruction is entered to add 2 ml of liquid from the dispensing reservoir (70% H₂O₂) to reaction container after 4 minutes automatically.

The third cycle is created for 30 minutes, with continuous stirring of the solution at 600 RPM only.

Option is selected to run all the cycles serially created before, and the method is saved under the name of choice for future reference. The housing chamber door 103 is closed and the start button on the GUI is pressed. The system prompted the completion of the reaction by inbuilt-alarm and indicator. The door is opened and synthesized nanomaterial zinc oxide (ZnO)/MWCNT nanoconjugate is collected, transferred in the appropriate container.

### Characterizations of Zinc Oxide (ZnO)/MWCNT Nanoconjugate (TEM, HRTEM, Raman)

In an embodiment, referring to FIG. 8 that shows the transmission electron micrographs (TEM) of zinc oxide (ZnO) nanostructures/MWCNT nanoconjugate. The TEM image clearly shows the nanoparticles with average particle size of 30 nanometers and the carbon nanotubes with an average outer diameter of 20 nanometers.

In an embodiment, referring to FIG. 9 that shows the high-resolution transmission electron micrographs (HRTEM) of zinc oxide (ZnO) nanostructures/MWCNT nanoconjugate. The HRTEM image shows the lattice fringes of 0.25 nanometer and 0.35 nanometer for ZnO and MWCNT respectively.

In an embodiment, referring to FIG. 10 that shows the Raman spectrogram of zinc oxide (ZnO) nanostructures/MWCNT nanoconjugate. The Raman spectrum shows the peaks of both the counterparts of the nanoconjugate, i.e., zinc oxide nanoparticles and MWCNT. No peaks of impurities are detected, indicating that the nanoconjugate achieved is pure.

### Example 2

### Characterizations of Urchin Like Copper Oxide Nanostructures (TEM, SEM, XRD, EDX)

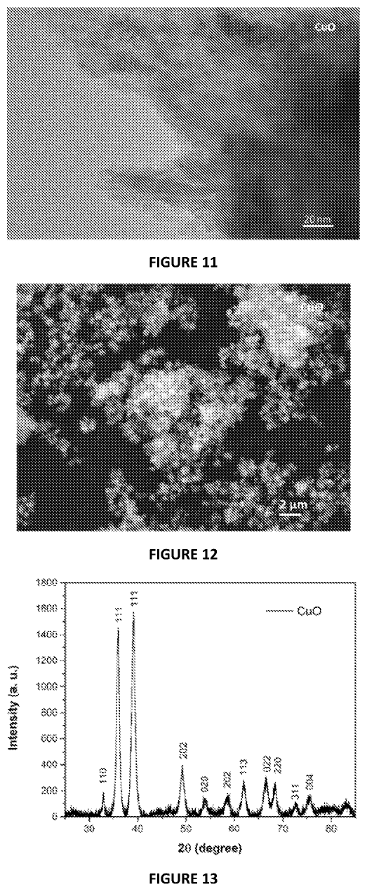

In an embodiment, referring to FIG. 11 that shows the TEM of urchin copper oxide (CuO) nanostructures. The TEM image clearly shows the surface spikes with an average size of 25 nanometer.

In an embodiment, referring to FIG. 12 that shows the SEM of urchin like copper oxide (CuO) nanostructures. The SEM image clearly shows the urchin like surface morphology, highly mono dispersed, nanostructures with an average particle size of 250 nanometers.

In an embodiment, referring to FIG. 13 that shows the X-ray diffractogram (XRD) of urchin like copper oxide (CuO) nanostructures. The XRD pattern confirms the crystalline nature of the material and matches the reference JCPDS card number 087125. No peaks of impurities are detected, indicating that the CuO nanostructures are pure.

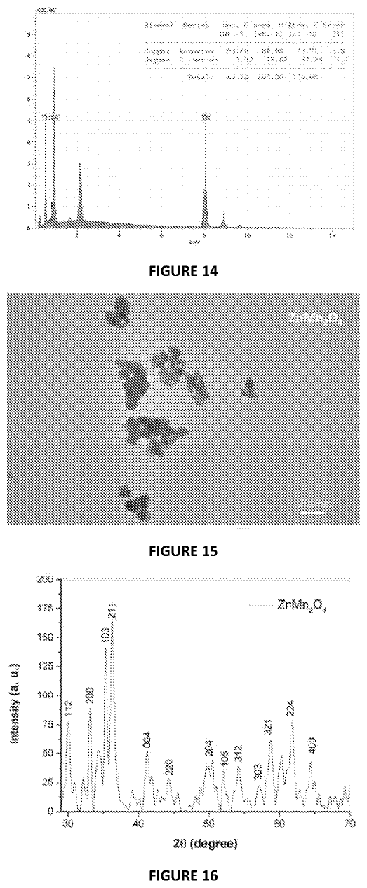

In an embodiment, referring to FIG. 14 that shows the energy dispersive X-ray (EDX) analysis of urchin like copper oxide (CuO) nanostructures. Urchin-like CuO nanostructures EDX spectra confirm the elemental presence of copper and oxygen. The EDX peaks at ^{˜}1.0 keV and ^{˜}8.0 keV energy could be assigned to CuK and peak at ^{˜}0.5 keV energy could be assigned to OK.

### Example 3

Characterizations of Zinc Manganese Oxide (ZnMn₂O₄) Nanostructures (TEM and XRD)

In an embodiment, referring to FIG. 15 that shows the TEM of zinc manganese oxide (ZnMn₂O₄) nanostructures. The TEM image clearly shows the nanoparticles with average particle size of 80 nanometers.

In an embodiment, referring to FIG. 16 that shows the XRD of zinc manganese oxide (ZnMn₂O₄) nanostructures. The XRD pattern confirms the crystalline nature of the material and matches the reference JCPDS card number 24-1133. No peaks of impurities are detected, indicating that the ZnMn₂O₄ nanostructures are pure.

### Example 4

Characterization of Iron Oxide (Fe₃O₄) Nanoparticles (TEM)

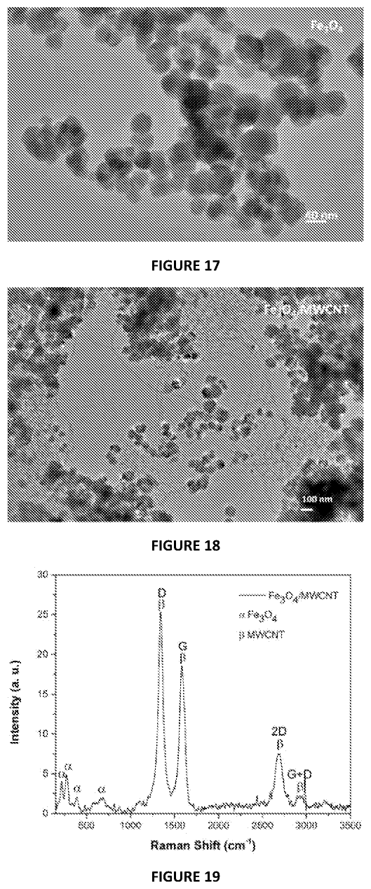

In an embodiment, referring to FIG. 17 that shows the TEM of iron oxide (Fe₃O₄) nanoparticles. The TEM image clearly shows the nanoparticles with average particle size of 50 nanometers.

### Example 5

Characterizations of Iron Oxide (Fe₃O₄)/MWCNT (Multi Walled Carbon Nanotubes) Nanoconjugate (TEM, Raman)

In an embodiment, referring to FIG. 18 that shows the TEM of Iron oxide (Fe₃O₄)/MWCNT (multi walled carbon nanotubes) nanoconjugate. The TEM image clearly shows the nanoparticles with average particle size of 70 nanometers and the carbon nanotubes with an average outer diameter of 20 nanometers.

In an embodiment, referring to FIG. 19 that shows the Raman spectrogram of Iron oxide (Fe₃O₄)/MWCNT (multi walled carbon nanotubes) nanoconjugate. The Raman spectrum shows the peaks of both the counterparts of the nanoconjugate, i.e., iron oxide nanoparticles and MWCNT. No peaks of impurities are detected, indicating that the nanoconjugate achieved is pure.

### Example 6

### Characterizations of Zinc Oxide (ZnO) Nanostructures (XRD, Raman)

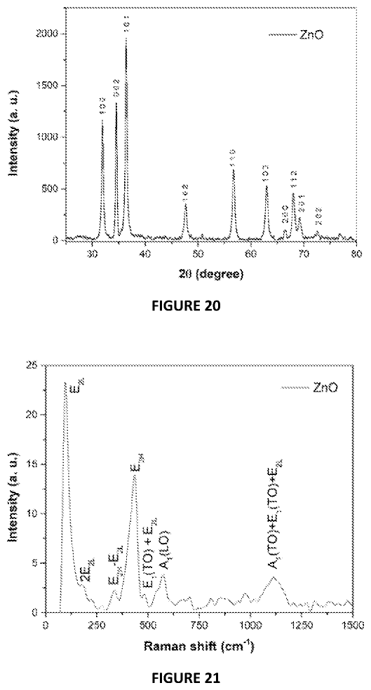

In an embodiment, referring to FIG. 20 that shows the XRD of zinc oxide (ZnO) nanostructures. The XRD pattern confirms the crystalline nature of the material and matches the reference JCPDS card number 36-1451. No peaks of impurities are detected, indicating that the ZnO nanostructures are pure.

In an embodiment, referring to FIG. 21 that shows the Raman spectrogram of zinc oxide (ZnO) nanostructures. The Raman spectrum shows the characteristic peaks of ZnO nanostructures. No peaks of impurities are detected, indicating that the nanoconjugate achieved is pure.

We claim:

1. A system 100, comprising of including but not limited to highly customizable nanoscale materials synthesis machine, accompanying graphical user interface (GUI), variable power supply:
involving but not limited to varying methods of manipulation, synthesis, manufacture, reaction, experiment, study, alteration, modifications, research, development;
of different variety of nanoscale, microscale or bigger materials with different properties, characteristics, quantity;
automatically or manually or in combination of both;
by applying different parameters including but not limited to different measurable, controllable, recordable variables of pH, heat, temperature, pressure, electrical conductivity, induction, electrical discharges, magnetic fields, wave, mechanical waves, mechanical vibrations, electromagnetic waves within and beyond range of wavelength of ultra violet, infra-red, visible, microwave lights;
on solid, liquid gas medium, solvents, solutes and different precursors.

2. A nanoscale materials synthesis machine 100 comprising but not limited to:
a housing 101;
a touch-display panel with graphical user interface mounted on the front of the housing 101 for the user;
a plurality of door can be transparent/opaque/translucent may be covered with hazardous stray light blocking sheets for a wide range of electromagnetic spectrum and other hazardous effects;
the door comprises automated and or manual door opening/closing system using linear actuators or gas struts or any other type of motion system and a door lock mechanism;
a plurality of indicators mounted on the housing 101 for display of status of machine in terms of such as process, events, experiments, errors, warning, cautions;
a plurality of switches such as to control power supply, handling emergencies, safety, and fuses mounted on the housing 101;
a panel for connecting power supply to the machine and data exchange mounted on the housing 101;
a plurality of different circuit board, power distribution, cables, data/memory(s) 203 storage, processor(s) 202, peripheral(s) 201 and data exchange interfaces mounted on and inside the housing 101;
a housing chamber 103;
a working platform i.e., workstation 104;
a variety of reaction container 105 as per need or desire of user;
a plurality of cooling system(s), exhaust system(s), a plurality of sensor(s) for such as temperature, Infra-red, humidity, gas, proximity sensor(s);
a plurality of electromagnetic wave sources within and beyond wavelengths, frequency of such as ultra-violet, infra-red, visible, microwave;
an automated motion system to handle, manipulation of materials, probes, electrodes in the housing chamber 103 such as horizontal, vertical, axial and, or robotic multi-dimensional;
a plurality of material holders to hold or mounting of such as materials; a plurality of electrodes to provide variable electric field waveform; a plurality of probes such as to monitor and or access the pH values of the synthesis and or experiment events with respect to time, ultrasonic transducers, liquid handlers, dispenser tips;
a plurality of cameras to record series of events, wherein the recorded series of events are uploaded and stored in inbuilt/internal storage system 203 and or to a cloud system through inbuilt Wi-Fi connectivity and or to any external storage system;
a heater; a stirrer with variable adjustable, controllable rotations per minute (RPM);
a sonicator with variable controllable adjustable power with respect of time; a water bath;
a software program, firmware, algorithm and graphical user interface 110, 111, 112 operable on multiple devices including but not limited to touch-display panel, desktop, mobile phone, tablets, compatible to multiple operating system like windows, MacOS, Linux, android, and many more for observation, control, operation, management, recording, analysis, of the system 100.

3. A nanoscale material synthesis machine variable electric field power supply 106 comprising of;
a housing;
a touch-display panel with Graphical user interface mounted on the front of the housing for the user;
a plurality of switches to control power, voltage, current, indicators, cooling, and or exhaust fan are mounted on housing;
a housing chamber housing adjustable castor wheel and or padding; a plurality of controllers, printed circuits boards, motors, gears and many more;
wherein the modules can be used for the nano scale material synthesis machine or independently for other purpose to provide variable waveform of current, voltage, frequency output through one or more components or independently as required;
wherein the electric field waveforms type can be monitored, changed and selected such as sine wave, square wave, pulsating, triangle, sinusoidal, sawtooth and many more;
wherein values of voltage and current monitored, changed and selected as a variable Alternating current (AC)/Direct current (DC) component, filtered, full wave or half wave or variably rectified waveforms and values can be selected and changed appropriately such as average, root mean square (RMS), peak (PK), peak to peak (PK to PK), and many more;
wherein the power supply electric field can monitored/regulated/controlled as per different potentiostat and or, galvanostat methods including but not limited to cyclic voltammetry, linear sweep voltammetry, chronoamperometry (cyclic step/double step), square wave (cathodic/anodic) stripping voltammetry, differential pulse voltammetry, chronopotentiometry, open-circuit voltage, differential pulse stripping voltammetry, staircase voltammetry, bulk electrolysis, and many more, can be provided to the multiple separate reaction events while providing separate set of instruction of parameters creating a multi-channel system;
wherein multiple desired output waveforms can be selected with respect to time, magnitude, values in parallel or serially;
a dedicated software program, algorithm and graphical user interface operable on multiple devices including but not limited to touch-display panel, desktop, mobile phone, tablets, compatible to multiple operating system like windows, MacOS, Linux, android, and many more for observation, control, operation, management, recording, analysis, of the nanoscale material synthesis machine variable electric field power supply module.

4. A method of synthesis, manufacture, reaction, experiment, study, alteration, modifications, research, development of different variety of nanoscale, microscale or bigger materials with different properties, characteristics, quantity, manually or automatically or in combination of both;
wherein by applying combination and permutation of parameters including but not limited to different measurable, controllable, recordable variables of pH, heat, temperature, pressure, electrical conductivity, induction, electrical discharges, magnetic fields, wave, mechanical waves, mechanical vibrations, electromagnetic waves within and beyond range of wavelength of ultra violet, infra-red, visible lights on solid, liquid gas medium, solvents, solutes and different precursors;
wherein the steps involved are as;
user select, install, prepares the reaction container 105 and add precursors of choice, electrodes, capping agents, surfactants, surface modifiers, metal salts, and many more as required for manipulation, synthesis, experiment, modification, alteration, study of nanomaterials or its process, methodology, or final nano, micromaterial of choice;
selects and connect any one or in combination of modules required to operate and enter their parameters with respect to time from any one of the graphical user interfaces i.e. touch-display panel 112 or mobile application 111 or dedicated desktop software application 110;
software check, verify, validate all the parameters entered and selected module, in case of wrong parameters, Software prompts error and asks user to re-enter correct setting;
in case of right parameters, the nanoscale material synthesis machine will perform the specified task as per user specified parameters with respect of specified time;
user collect the products, residues and can view, study, analyze, process the reports and records along with graph plots of the process and can be printed through, printer and or stored in inbuilt memory(s) 203 and or to external computer.

5. A use of nanoscale materials synthesis machine system 100 recited in claim 1 to synthesize or manufacture varied types of nanoscale, microscale, bulk and or bigger materials;
Including but not limited to metal nanomaterials, metal oxide, hydroxides, carbonates, sulphides, core shell, bimetallic, thin films, nanorods, nanotubes, nano scale composites, dispersions in different solvents medium, organic and or polymer coatings on nanoscale materials, of different desired properties including but not limited to size, morphology, concentration, surface functionalization, composites, biocompatible nanomaterials with polymeric coating, and many more with different quantities.

6. A product ZnO/MWCNT nano conjugate FIG. 9, FIG. 10, FIG. 11, prepared using our novel process in system/machine 100.

7. A process FIG. 8 of making zinc oxide (ZnO)/MWCNT nanoconjugate material: where in the process of steps;
the appropriate reaction container 105 is selected, installed;
the reaction container Is prepared by adding 200 ml of deionized water, 25 mg of MWCNT, 2 M of NaCl;
the dispenser reservoir is filled with 2 ml of 70% H₂O₂ to dispense automatically 2 ml of 70% H₂O₂, 4 minutes after the starting time of second cycle of reaction event;
two Zinc (Zn) electrodes with the dimension 70 mm length and 6 mm diameter is mounted on the electrode stand;
multiple operational time cycles are created and instructions to perform different functions at each cycle is provided;
the GUI is accessed and the parameters to keep 70° C. of the solution are entered for the first cycle of one hour at 600 RPM of stirring;
the instruction to move down 25 mm of the electrode in the solution at a spacing of 40 mm in between of electrodes is entered when the temperature of the solution 70° C. is achieved;
the instruction to supply unfiltered direct current from variable power supply 106 with constant voltage at 4 V second cycle for 6 minutes is entered;
instruction to add 2 ml of 70% H₂O₂ in the reaction container, 4 minutes after the starting of second cycle is entered;
the instruction to stir the solution in the reaction container continuously at 600 RPM for next 30 minutes is entered for third cycle;
the parameters are checked and the machine is started;
once the cycle of action is completed by machine system 100, the ready product nano conjugate of ZnO-MWCNT is collected and or all related records are collected, printed, stored, analyzed as per requirement of the user.

8. Our right to further claim independent patents for the novel, nonobvious, process and products developed by us on nanoscale materials synthesis machine system 100 for the other quoted examples and other then these quoted examples.
